(19) United States
(12) Patent Application Publication
(10) Pub. No.: US 2008/0179426 A1
(43) Pub. Date: Jul. 31, 2008

(54) Rain Maker

(76) Inventor: Plas Johnson, Phoenix, AZ (US)

Correspondence Address: BOOTH UDALL, PLC, 1155 W. Rio Salado Pkwy., Suite 101, Tempe, AZ, 85281, US

(21) Appl. No.: 11/552,891

(22) Filed: Jan. 30, 2007

(51) Int. Cl. B05B 15/00

(52) U.S. Cl. 239/289; 239/373

(57) ABSTRACT

The Rainmaker is a personal umbrella combined with a pressurized misting system. Misting nozzles attach directly to the ribs of the canopy, using the ribs as an avenue for pressurized liquid. These objects do not hinder the ability to operate the opening and closing of the umbrella. The shaft of the umbrella acts as a reservoir and contains the water for misting. The handle doubles as a hand pump, creating the necessary pressure needed to create a proper mist. This self-contained unit promises a mobile, self-reliant, ecology minded, personal cooling, and humidified surroundings.

### SUMMARY OF INVENTION

The objective of this invention is to provide a convenient and portable personal misting and mobile shade device. To accomplish this, an umbrella is fabricated with avenues for pressurized water flow to misting nozzles placed at the six ends. The shaft of the umbrella is converted into a water reservoir and pump to provide the needed pressure and water for proper mist.

Users can adjust water pressure and humidity levels in their surroundings by pumping more pressure into the water reservoir and spinning the umbrella to create a surrounding of cool mist. Water travels from the reservoir with pressure from the pump, through the specially fabricated hollow aluminum shafts to the water nozzles.

### BRIEF DESCRIPTION OF DRAWINGS

FIG. 1 is a perspective view, with portions broken away, showing a misting umbrella, and reservoir with pump, in accordance with the present invention.

FIG. 2 is of the umbrella tarp with aluminum spreaders with the present invention.

FIG. 3 is an enlarged cross-sectional view of the central umbrella canopy, showing the connection between the water supply tubing and the distributional tubing in accordance with the present invention.

FIG. 4 is a partial perspective view, with portions broken away, showing the 6-way water distribution under the umbrella, through the shafts in accordance with the present invention.

FIG. 5 is a detailed perspective view of the shaft. The shaft acts as a reservoir for water and a pump to provide pressure to make mist in accordance with the present invention.

### DETAILED DESCRIPTION

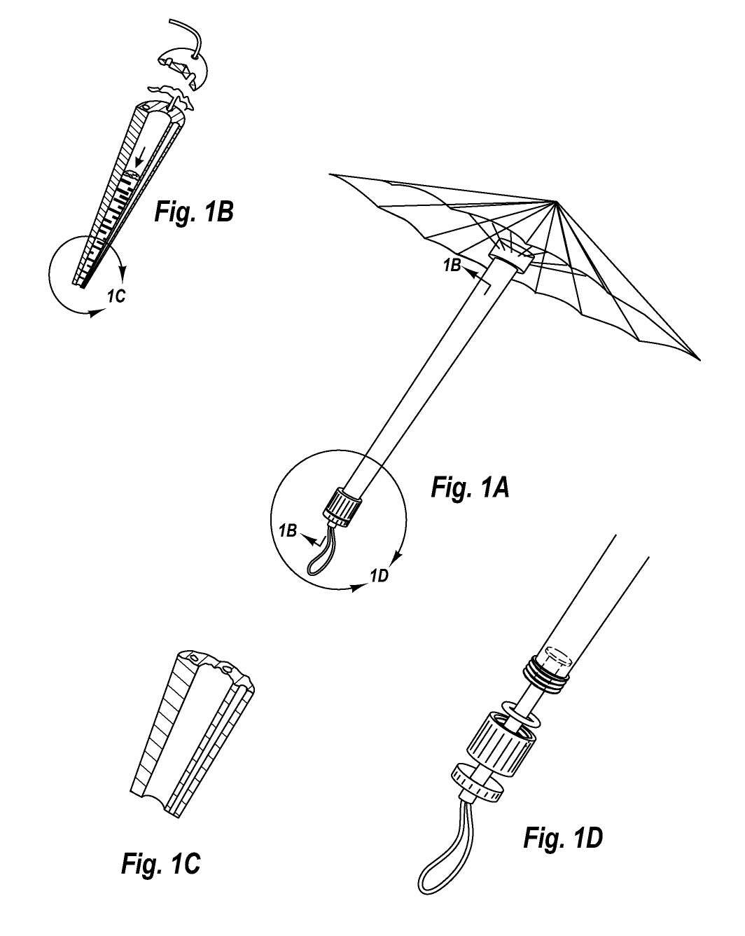

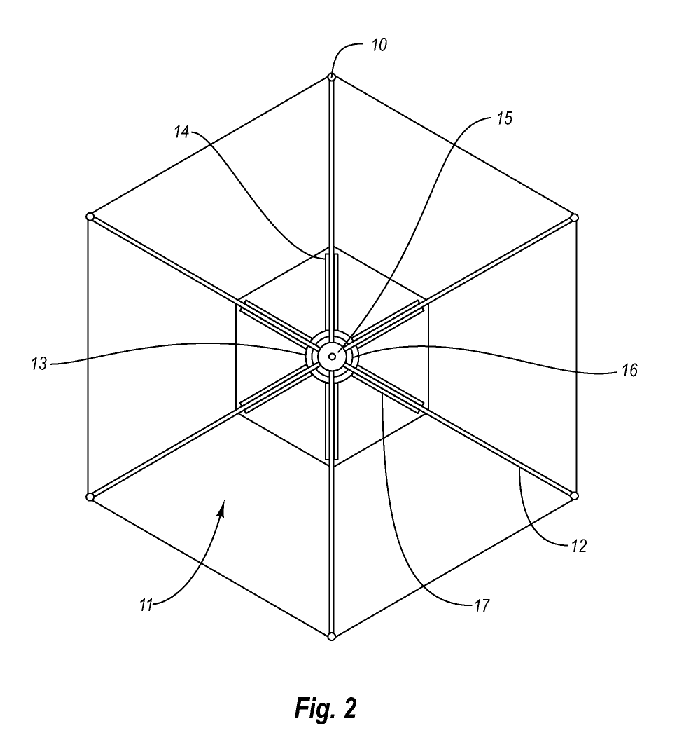

References to like parts will be referenced for FIGS. 2-5. For a complete listing of all pats and official site key, please refer to page 7 of this document. FIG. 1 is an initial drawing of present invention and will not be described in this section.

FIG. 2 shows the bottom of the umbrella tarp (11) in an open position. The purpose of this drawing is to show the degrees of the 6-arm design. The shaft spreader mount (13) is shown in an open position locked with the spreader arm (17). In a closed position, the shaft spreader mount will slide down. When in an open position each spreader arm (17) is 60 degrees from arm on either side. These spreader arms are connected to the aluminum hollow spreaders (12) via aluminum rivet joints (14). The aluminum hollow spreader connects to the top spreader mount (15).

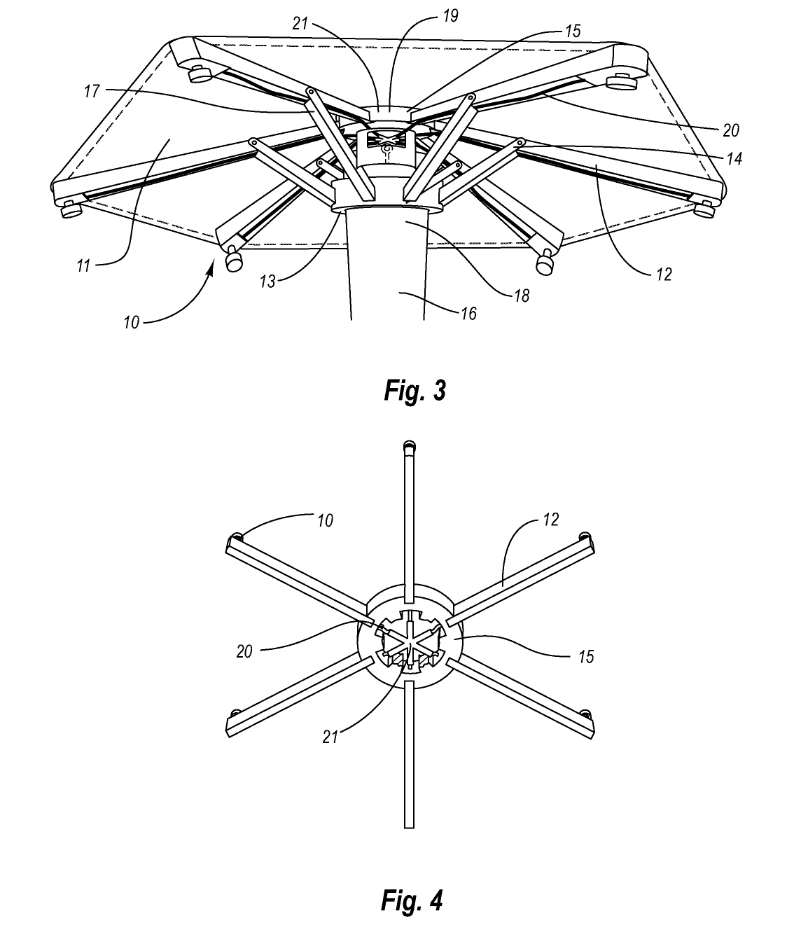

FIG. 3 shows a detailed side view of the rainmaker. The shaft Cylinder (16) is the base for the shaft spreader mount (13) to slide up and down. The lock (18) holds the shaft spreader arm in an open position. As the spreader arm (13) is pushed into an opening position the spreader arms (17) push the aluminum hollow spreaders up in an opening position. These spreader arms are connected to the aluminum hollow spreaders (12) via aluminum rivet joints (14). The aluminum hollow spreaders are mounted to the top spreader mount with aluminum rivet joints (14). The ¼″ high pressure flexible mist line (20) runs through the hollow aluminum arm (12) and connects to the Brass and stainless steel flex nozzles (10) providing mist. The other end of the ¼″ high-pressure flexible mist line (20) connects to the top spreader mount (15). This portion of present invention will be discussed thoroughly in FIG. 4. The Off and on dispenser switch (19) is located at the top of the shaft Cylinder (16) and controls the pressure at which water is being dispensed at the brass and stainless steel flex nozzles (10) by twisting clockwise to increase pressure and counter clockwise to decrease and or turn off water.

FIG. 4 shows a detailed top view of the top spreader mount (15). Its purpose it to show the revolutionary 6-way water dispenser (21) and its connection to the ¼″ high-pressure flexible mist line (20). The other end of this line connects to the brass and stainless steel flex nozzles (10). This nozzle is connected to the aluminum hollow spreader (12) and the ¼″ high-pressure flexible mist line (20) runs through the hollow portion of the arm.

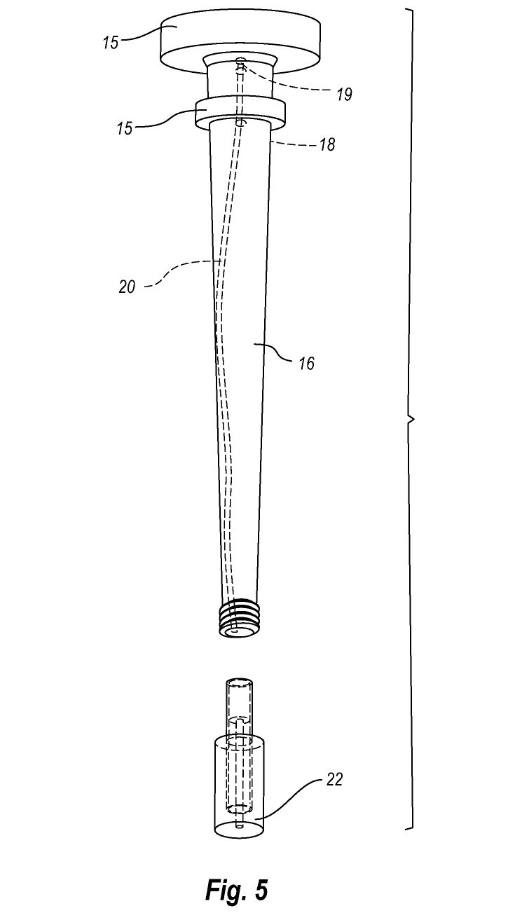

FIG. 5 shows a detailed side view of the shaft cylinder (16). This portion of the rain maker is hollow, is used as a water reservoir, and holds air pressure produced by handle pump (22). A piece of ¼″ high-pressure flexible mist line (20) travels from the bottom of the water reservoir to the off and on dispenser switch (19). The off and on dispenser switch (19) connects directly to the 6 way water dispenser (21) allowing all six brass and stainless steel flex nozzles (10) to receive pressurized water for misting.

1. A misting umbrella comprising a hollow shaft for holding water and air pressure.

2. The misting umbrella of claim 1 further comprising a mist line running through an interior of the hollow shaft.

3. The misting umbrella of claim 2, wherein the mist line runs from a bottom of the hollow shaft up to a water dispenser.

4. A misting umbrella comprising a handle pump assembly for providing air pressure, the handle pump assembly disposed at a distal free end of a hollow shaft.

5. The misting umbrella of claim 4, wherein the handle pump assembly comprises:
a handle member removably coupled to the distal free end of the hollow shaft; and
a pump member slidably coupled to the handle member.

6. The misting umbrella of claim 5, wherein the pump member comprises a piston movable within an interior of the hollow shaft.

7. A misting umbrella comprising:
a hollow shaft cylinder for holding water and air pressure, the hollow shaft cylinder having a distal free end; and
a handle pump assembly for providing air pressure, the handle pump disposed at a distal free end of the hollow shaft cylinder.

8. The misting umbrella of claim 7 further comprising a mist line running through an interior of the hollow shaft cylinder.

9. The misting umbrella of claim 8, wherein the mist line runs from a bottom of the hollow shaft cylinder up to a water dispenser.

10. The misting umbrella of claim 7, wherein the handle pump assembly comprises:
a handle member removably coupled to the distal free end of the hollow shaft; and
a pump member slidably coupled to the handle member.

11. The misting umbrella of claim 10, wherein the pump member comprises a piston movable within an interior of the hollow shaft.
